(19) United States
(12) Patent Application Publication
(10) Pub. No.: US 2010/0295373 A1
(43) Pub. Date: Nov. 25, 2010

(54) METHOD AND APPARATUS FOR THE LOSS-FREE TRANSMISSION OF ELECTRICAL ENERGY

(76) Inventor: Rolf Eisenring, Eglisau (CH)

Correspondence Address: NIXON & VANDERHYE, PC, 901 NORTH GLEBE ROAD, 11TH FLOOR, ARLINGTON, VA, 22203, US

(21) Appl. No.: 12/740,844

(22) PCT Filed: Oct. 31, 2008
(86) PCT No.: PCT/IB2008/002917

§ 371 Date: Jul. 20, 2010

(30) Foreign Application Priority Data
Oct. 31, 2007 (CH) 01688/07

(51) Int. Cl. H02J 9/00

(52) U.S. Cl. 307/66

(57) ABSTRACT

In a method and an apparatus for the loss-free transmission of electrical energy between a DC source and a lossy load circuit, the DC source is connected, via a radio-frequency broadband line, to at least one quantum storage cell which feeds the lossy load circuit, with the result that the electrical energy is transmitted from the DC source to the quantum storage cell in the form of current pulses corresponding to the Dirac function.

The invention relates to a method and apparatus for the loss-free transmission of electrical energy between a direct-voltage source and a lossy load circuit.

When conventional electrical current flows through a metallic conductor, the current causes a voltage drop at the resistance of the conductor, thus causing a portion of the transported energy to be irreversibly lost in the form of heat. In order to keep such losses low, it is feasible to either decrease the resistance by increasing the cross section of the conductor or reduce the current by the step-up transformation of the transmission voltage. With the superconductivity of special materials at elevated temperatures (170° K), another option to reduce the line resistance during the transmission of energy has recently been tried to be utilized.

The present invention aims to provide a method and a device, by which the transmission of electrical energy between a direct-voltage source and a lossy load circuit takes place without loss.

To solve this object, the invention essentially provides that the direct voltage source is connected, via a high-frequency broadband line, with at least one quantum storage cell feeding the lossy load circuit, so that the electrical energy is transmitted from the direct voltage source to the storage cell in the form of current pulses corresponding to the Dirac function and causing undeterminable virtual voltage drops according to Heisenberg's uncertainty relation.

This enables electrical energy to be transmitted extremely rapidly through almost arbitrarily thin metallic conductors without involving losses in the form of heat so as to enable a considerable reduction of the expenditures and costs involved, in particular, in the transmission of large energy amounts over large distances. In addition, the invention, in special applications, allows very large currents to flow in the minutest spaces and, in the micro-range, e.g. in highly integrated circuits, the switching speeds of conventional computers to be strongly increased, and the cooling costs for mainframe computers to be reduced, because of the reduced dissipation heat. The invention may, however, also be employed for the transmission of electrical energy by large-distance high-capacity direct-voltage transmission between conventional power plants or solar plants and consumers. It is equally conceivable to use the invention for the intra-city energy distribution over smaller distances as well as for the daily power supply to stationary or mobile consumers. The invention can, moreover, be used to feed electronic components of highly integrated circuits in the sub-millimeter range.

The invention benefits from the new quantum-physical effect of virtual photon resonance, in which a so-called quantum storage cell or quantum battery (cf. WO 2004/004026 A2), i.e. a storage cell which is able to take up current pulses substantially corresponding to the Dirac function, is charged with very short current pulses. A quantum storage ceil is based on the physical effect according to which very small particles of a chemically strongly dipolar crystal material, which are mutually separated by an insulating medium, become conductive under the influence of a strong electrical field and at a critical voltage due to the effect of virtual photon resonance, said particles thus locally concentrating the homogenous electrical field within a very short time to such an extent that a loss-free charge exchange via current pulses substantially corresponding to the Dirac function and having a constant voltage will be induced.

In this context, it is preferably provided that the crystals are in the form of nano-grains or in the form of layers having nanometer thickness. The crystals are preferably present in the rutile crystal modification and, preferably, configured as TiO₂ crystals. The structure is preferably chosen such that the crystals and the insulating material are provided in alternately superimposed layers. Regarding the structure and further configurations of the quantum storage cell, it is referred to WO 2004/004026 A2, which is hereby incorporated in the disclosure of the present application by way of reference.

The particles of the chemically strongly dipolar crystal material, preferably TiO₂, in the rutil crystal modification are able, on the one hand, to take up and store the described energy present in the form of current pulses substantially corresponding to the Dirac function and, on the other hand, to also release the same in the form of power by emitting such current pulses. Yet, a charged quantum storage cell is also able to feed lossy, conventional electric circuits on account of the voltage difference on the two poles.

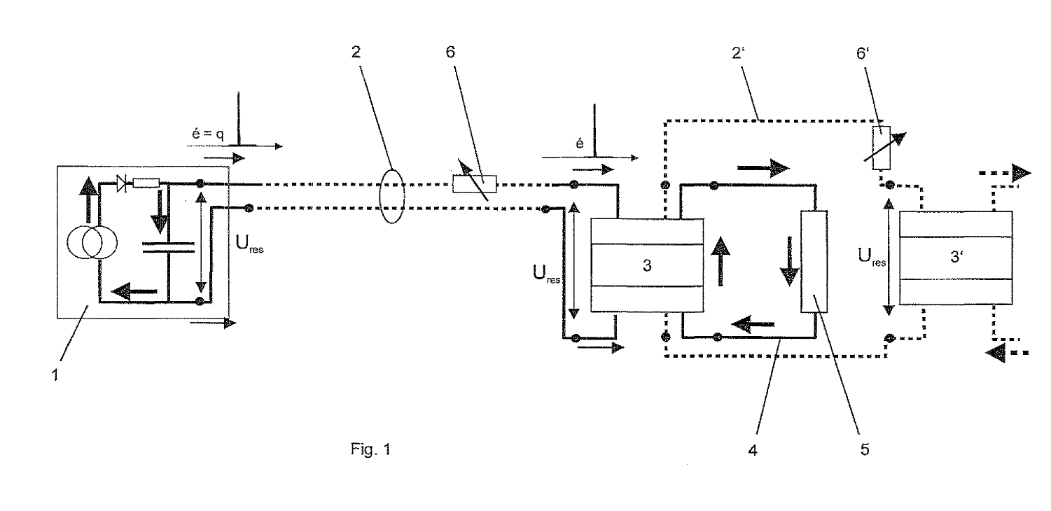

The described current pulses are the result of the singular quantum jumps occurring within the resonator crystals contained in the storage cell. Externally, they appear as ideal Dirac current pulses. Such current pulses are characterized in that, temporally, they occur never together, or separated by extremely small time intervals (Pauli principle), that their effective current values are very small at constant voltages and their jump energy will therefore be below the limit of Heisenberg's uncertainty relation, and that they will only be able to flow if the conductor bandwith is larger than approximately 100 MHz (cf. FIG. 1). Such currents are virtual currents, causing no “determinable” voltage drops at the electrical line resistance (uncertainty relation). These currents will also be referred to as “cold” currents below, By Maxwell's equation (1865), which relates the magnetic field H to the current j and a displacement current ∂D/∂t, these cold currents are clearly defined in that, in the equation, the current term “j” by Ampere (1821) is set to zero, whereby the constant-voltage nature of the cold currents is defined.

Movement through the conductor of the massy electrons of the cold current is effected at light speed (by individual jumps, cf. FIG. 1); to this end, they are, however, each individually packed within a reversible dynamic “grey hole” (an extremely strong, yet reversible curvature of the spacetime) and hidden behind an uncertainty horizon (Heisenberg's uncertainty relation).

The curvature of the spacetime (Minkowski 1908) into a dynamic grey hole causes relativistic effects such that the movement of the charge particles present therein will effectively perform a journey through the near (grey) future of the spacetime as a “cold current”, a space/time movement which, however, exceeds any imaginative power of man. These procedures are, therefore, not measurable physically “Here and Now”, or undeterminable (cf. Heisenberg's uncertainty relation). The only effectively measurable phenomenon is the time dilatation occurring on account of the space/time curvature, of the electron jumps, which take place in the quantum battery and only last for about 10⁻¹⁶ to 10⁻¹⁸ seconds there, yet are extended to a maximum of about 10⁻⁸ seconds (corresponding to the reciprocal value of the bandwith) in our world of perception.

The loss-free transmission of the electrical energy from the direct-voltage source to the lossy load circuit via the quantum storage cell now takes place in a manner that the quantum storage cell feeding the lossy load circuit for its recharging requires current pulses in the form of Dirac pulses as a function of the energy consumed by the lossy load circuit. This will, in particular, apply when the resonance condition for the quantum storage cell (U=Uᵣₑₛ) is met, which may preferably be realized by an adaptation of the output voltage of the direct-voltage source. In this context, a configuration in which a full-wave rectifier is provided as said direct voltage source is preferred. The direct voltage source, i.e. in the case of a rectifier the electrical field of the output capacitor of the rectifier, will send these pulses if the bandwidth of the transmission line is sufficiently large. The Dirac pulses will then reach the resonator of the quantum storage cell. The transmitted charge amount (charge per unit time=current) is not measured by the size of an amplitude, but by the sum of the pulses. If, however, the real bandwidth is too strongly limited, the Dirac pulses will deviate from the ideal form. This will cause the effective current values of the pulses to become measurable, i.e. the pulses will become wider with only a reduced number reaching the quantum storage cell. From too large a measure, the resonance on the quantum storage cell will completely terminate and the charging procedure or transmission will stop. This effect can be utilized to adjust the transmission power.

To control the energy flow, it may therefore preferably be proceeded in a manner that a bandwidth controller is arranged between the direct voltage source and the quantum storage cell, wherein the transmission is controlled by changing the frequency bandwith of the line. The energy flow can thus be arbitrarily controlled by a bandwith controller from the “cold side”, i.e. from the side on which the cold current flows. The charging procedure, or the resonance, will also be interrupted if the rectifier, due to overload, is no longer able to maintain the resonance voltage Uᵣₑₛ on the storage cell at its output voltage.

In order to locally distribute, and make available to stationary or mobile consumers, the energy transmitted from a direct voltage source in a loss-free manner, the configuration is preferably further developed such that the quantum storage cell is arranged in parallel with a further quantum storage cell via a high-frequency broadband line, and that a broadband controller is preferably arranged between the storage cells. It is, thus, possible to interconnect two quantum storage cells, for instance, in building heating systems or automobiles, whereby the energy flow amount can be controlled by a bandwith controller between the two storage cells.

In a preferred manner, it is proceeded according to the invention in that a further quantum storage cell is used as said direct voltage source.

According to a further preferred further development, it is provided that a solar cell or a photodiode is used as said direct voltage source. If a quantum storage cell is arranged to follow a photodiode via a fast (i.e., high-frequency broadband) line, it will require “cold” Dirac current pulses. The “hot”, i.e. classic, currents, and hence also the disadvantageous lossy heating of the cell, will be omitted, thus intensively increasing the efficiency of the photodiode.

In the event of large energy transmissions, it is preferably proceeded in a manner that a line designed to be elongate and flat in the manner of a quantum storage cell is used as said high-frequency broadband line. Since every storage cell that is able to take up current pulses substantially corresponding to the Dirac function, such as, e.g., a quantum storage cell, naturally has the bandwidth necessary for transmitting electrical energy to a quantum storage cell, it will thereby be ensured that a loss-free transmission will take place in any event. This may, for instance, be realized by interposing discrete (wound or flat) quantum storage cells directly in front of the consumers.

With larger transmission distances or higher currents, it is advantageously proceeded such that further quantum storage cells and/or bandwidth controllers are arranged within the line in a spaced-apart relationship. Due to the fact that the broadband line is interrupted at intervals by individual storage cells as boosters, the electrical energy can be transmitted over large distances in a loss-free manner without having to replace the existing wiring.

The high-frequency broadband line preferably has a bandwith of more than 90 MHz, thus ensuring that the Dirac current pulses will not loose their form and be transmitted in a lossy manner.

When using the invention for the transmission of energy in integrated circuits, the quantum storage cell in micro/nano dimension can be placed in a strategically beneficial manner in the center of the main consumers along with all other microelectronic components. In such applications, the conventional line feeds will, as a rule, do in respect to the broadbanded configuration required to transport the energy via Dirac current pulses (by “cold” currents) from the external feed points to the consumer centers on the chip. In such power lines no losses will occur, and hence less cooling of the chip will be needed. The power supply within the circuits of the chip, however, will take place in a conventional manner.

In the following, the invention will be explained by way of exemplary embodiments schematically illustrated in the drawing. Therein,

FIG. 1 depicts the structure of an apparatus according to the invention;

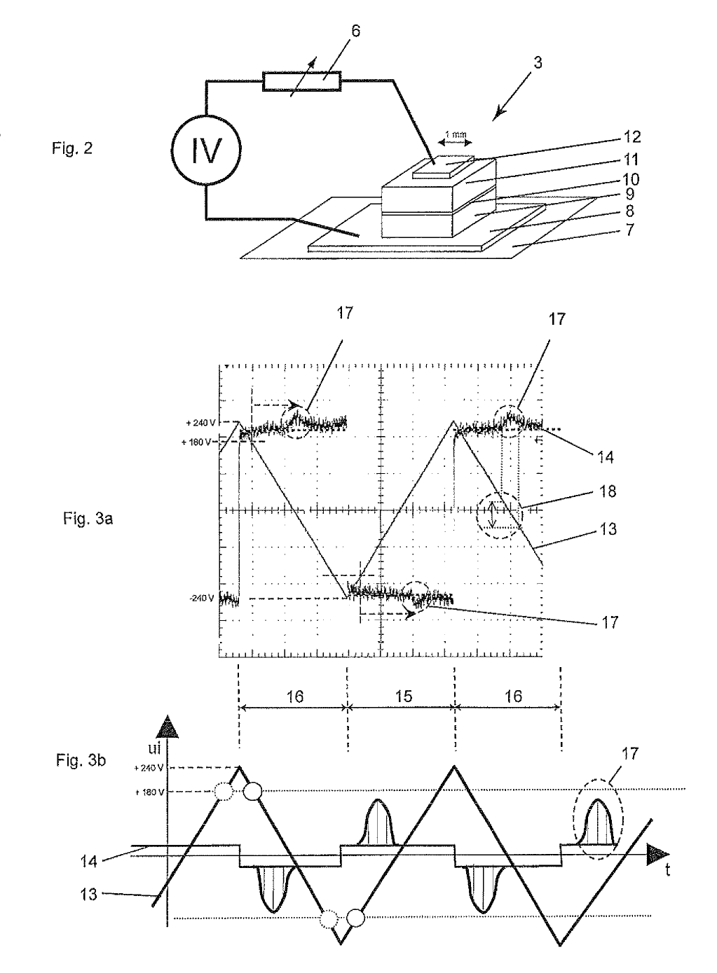

FIG. 2 depicts the structure of a quantum storage cell;

FIG. 3 shows the current course in a test array; and

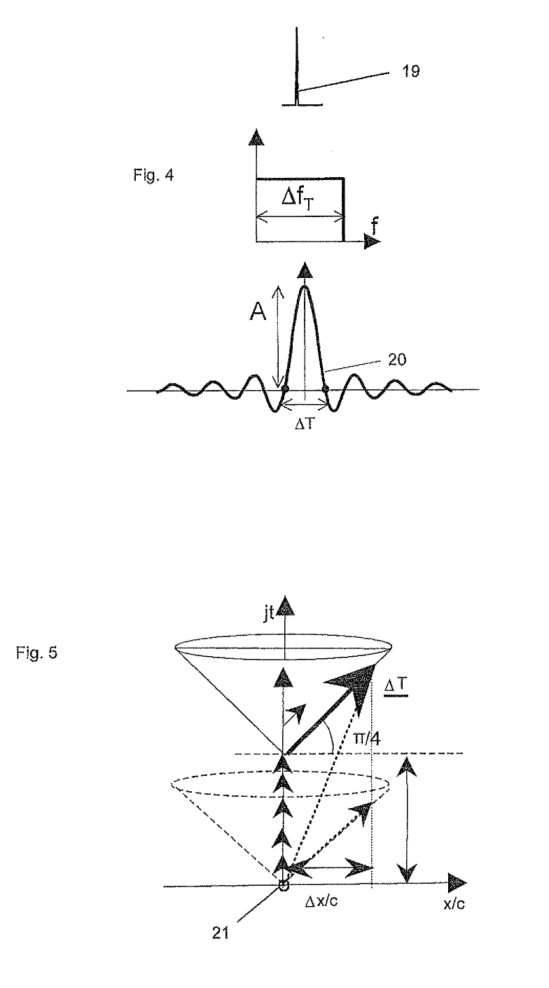

FIGS. 4 and 5 illustrate the physical mode of action.

In FIG. 1, a direct voltage source is denoted by 1, which, in the present case, is formed by an alternating voltage source and a full-wave rectifier. Alternatively, a photodiode or the like might be provided. A high-frequency broadband line such as, e.g., an UHF line, a thin and flat quantum storage cell or the like is denoted by 2. This line serves to transmit the current in a loss-free manner, wherein, in addition to the necessary bandwith on either side of the line 2, the same voltage and, in particular, the resonance frequency Uᵣₑₛ of the quantum storage cell or quantum battery 3 installed on the consumer-side must be available. Further quantum storage cells 3′ may be arranged consecutively to this quantum storage cell 3 via further UHF lines 2′, said further quantum storage cells being each able to feed a lossy power circuit 4, the consumer being denoted by 5. The current that can be delivered in this case results from the formula: I=Uᵣₑₛ/R, R being the resistance of the consumer. Since the transmission from the remote current source is free of losses and extremely fast, the voltage on the battery will remain constant irrespectively of the resistances of the consumers.

The internal resistance of the quantum storage cell 3 is negligibly small, since the output voltage will remain constant in a load-independent manner, The current which is consumed by the load 5 is as large as the current which is made available by the direct voltage source or the rectifier 1, with the quantum storage cell 3 remaining fully charged. Both currents, namely the current of the direct voltage source 1 and that supplied to the consumer 5, are classic (“hot”) currents, i.e. the moved charge is composed of collective particle movements of all line electrons. When meeting the resonance condition for the quantum storage cell 3, particularly (U=Uᵣₑₛ), which is realized by adapting the output voltage of the rectifier 1, the quantum storage cell 3 for recharging will require current pulses in the form of Dirac pulses which, by contrast, each consist of a whole singular movement (quantum jump) of an individual whole charge, i.e. an electron. The electric field of the output capacitor of the rectifier 1 will be able to deliver these pulses, if the bandwidth of the transmission line 2 is sufficiently large. The Dirac pulses will then reach the resonator of the quantum storage cell 3. The charge amount transmitted (charge per unit time=current) is not measured by the size of an amplitude, but by the sum of the pulses.

At the resonance condition, the quantum storage ceils, moreover, require Dirac current pulses from said further quantum storage cells 3′, which function as interposed booster cells and are charged very rapidly to more than 10⁹ MW/kg (power density) to capacities of more than 15 MJ/kg (energy density) at almost no resistance.

By 6 or 6′ is denoted a bandwidth controller which, in the simplest case, is comprised of a potentiometer. The interposed, variable resistor readily allows for the control of the demand of the quantum storage cell 3, wherein, at the same time, no or only very small real currents flow through the resistor so as to enable the simple and, above all, safe control of the consumption of large-scale consumers. By controlling the demand of the quantum storage cell 3, the current output of the quantum storage cell 3 will, at the same time, be accordingly limited or controlled.

FIG. 2 depicts a quantum storage cell 3 which is built on a silicon wafer 7 in the MIS (metal-insulator-semiconductor) architecture. It is comprised of a lower electrode 8 of an n+ silicite, a 300-nm-thick SiO₂ insulation layer 9, a central TiO₂ layer 10 of a pure rutile crystal having a thickness of 15 nm and produced by the MOCVD technique, a further 300-nm-thick insulation layer 11 of SiO₂, and a titanium electrode 12. The upper electrode 12 was structured into plane pieces having dimensions of 1 mm×1 mm so as to produce a capacity of approximately 60 pF each.

FIGS. 3a and 3b respectively depict the actual and the schematic IV measurement results of the array according to FIG. 2, wherein a saw-tooth voltage 13 of ±15000 V/s and ±240 V amplitude is applied to the sample at 15 Hz. Hence results a substantially rectangular current course 14 for the super-capacitor. The voltage source serves as an energy supplier at the rising voltage course 15 and as a load of the quantum storage cell during the descending voltage course 16. The quantum storage cell is a constant voltage source and, if a higher voltage is imposed by the feed source, will short-circuit the latter until it will itself be completely charged, and, accordingly, will itself be short-circuited during discharging by the feed source (the latter then being the load). But because of the extremely fast charging, the charging short-circuit current cannot be seen, yet the discharging current is easily visible in the region 17. The capacitor shows the typical current behavior below about ±150V and, above, will change to a battery. Between 150 V and 190 V, additional energy-rich charge carriers in the form of the virtual cold current will flow onto the battery at extremely high speeds due to Dirac current pulses. If the voltage course is reversed, the battery will discharge with a conventional, lossy, hot current. All TiO₂-crystal molecule rows of identical length will discharge at an identical voltage. This voltage will then be maintained until complete depletion, wherein higher discharge current peaks will show up as a function of the speed of the forced step-down voltage. The measurement in FIG. 3a clearly shows that no currents are measured in the feed line leading to the quantum storage cell, the charge current being invisible or virtual: As a result, the energy flows in an absolutely loss-free manner onto the quantum storage cell. This is the cold current. Naturally, also a hot and lossy current flows within the voltage source, likewise on the feed line. The discharge current of the quantum storage cell over the external load is a classic, hot current and can, of course, be measured and observed. The region denoted by 18 is the region in which the super-capacitor can be operated as a constant voltage source, covering about 60V. The resistor 6 serves as a bandwith regulator and, at a value of 4.75 kΩ, limits the bandwith, and hence the energy flow to the quantum storage cell 3, already very strongly.

FIG. 4 depicts a perfect Dirac current pulse denoted by 19, wherein the temporal width of the pulse is virtually zero, yet the frequency spectrum equals one over the entire signal. Δƒ_{T} indicates the frequency bandwidth of a power line. If such a Dirac current pulse is sent via said one line with the limited bandwidth, the temporal width of the Dirac current pulse will be extended, or the frequency spectrum narrowed, since a Dirac current pulse is basically a superposition of all sine or cosine frequencies, yet not all of them can be transmitted because of the limited bandwidth. The spread current signal is denoted by 20 and indicated by the formula

i(t)=Asin (2πƒt)/(2πƒt)

The temporal width of the signal is denoted by ΔT, and the amplitude of the signal is denoted by A, the product being

A·ΔT=const=e

From the uncertainty relation,

ΔT≈1/Δƒ_{T}

can be deducted. A Dirac current pulse consequently transmits an effective current:

I_{RMS}≈e/\sqrt{2π}(=e/2)iπ ΔT→0

The actual energy in a Dirac current pulse is calculated from:

ΔE=Uᵣₑₛ·I_{RMS}·ΔT

which describes the actual jump energy of a Dirac current pulse. To cold currents, the following relation applies:

ΔE·ΔT<h

The energy of a pulse is thus smaller than the uncertainty relation stipulates for a measurement; the current is, therefore, virtual, causing no dissipation. An energy quantum

▴=eUᵣₑₛ

can, therefore, be transported without energy/heat loss, or without increasing entropy. According to the Pauli exclusion principle, these energy quanta will never occur simultaneously, which is why the current pulses will never add up to a measurable joint amplitude. The overall energy transmitted, however, is calculated from the sum of the transmitted Dirac current pulses.

From the above considerations follows that the conditions for the bandwidth for the loss-free transmission of energy is given by the following formula:

Δƒ_{cc}=1/ΔT=\sqrt{Uᵣₑₛ·I_{RMS}/h} [symbol] Δƒ_{T}>Δƒ_{cc}

Physically this means that mass-carrying electrons move with an energy quantum at light speed, yet each individual electron is hidden in a dynamic, reversible grey hole behind an uncertainty horizon due to the strong spacetime curvature.

Quantum mechanically the particle energy can be equated with the wavelength using Schrödinger's equation:

$$\frac{{ℏ}^{2} {δ}^{2}}{2 m δ {x}^{2}} Ψ = \frac{- j ℏ δ}{δ t} Ψ$$

The left-hand side describes the kinetic jump energy, wherein the jump of an electron into a hole is described in the Fermi energy distribution, and the right-hand side describes the electrical wave energy. The effective (RMS) kinetic jump energy is also given by

$${Ψ}_{RMS} = {mc}^{2} = m \frac{Δ {x}^{2}}{Δ {T}^{2}}$$

and the effective (RMS) wave energy is given by

Ψ_{RMS}=E=U·IΔT

If only the physically observable factors are taken from the two terms of the kinetic jump energy and from the two terms of the wave energy, the equation

$$\frac{ℏ}{2 Δ {T}^{2}} = \frac{- j δ E}{δ t} = - j P$$

will be obtained, wherein P corresponds to the effective value of the power (i.e. P=UᵣₑₛI_{RMS}). According to the uncertainty relation in an imaginary time, the left-hand side of the equation must be larger than the right-hand one, from which results:

$$\frac{ℏ}{2 Δ {T}^{2}} > \frac{- jδ E}{δ t} ⇒ \vert Δ T \vert \leq \sqrt{h / {U}_{res} \cdot {I}_{RMS}}$$

This corresponds to the minimum bandwidth requirement for the line, thus an approximate minimum bandwith of more than 90 MHz is required.

FIG. 5 shows a modified Minkowski illustration of the spacetime with local nano-curves through grey holes transporting mass particles at light speed. Here, the Minkowski length |ΔT| is the time that is perceived of the movement or the quantum jump, with the particle moving at light speed. The time in the grey hole is, however, strongly decelerated. The Minkowski length in this case is given by

ΔT²=jh/(Uᵣₑₛ·I_{RMS}) [symbol] ΔT=e^{jπ/4}\sqrt{h/Uᵣₑₛ·I_{RMS}}

describing the longest time of movement as measured outside the grey hole. In the world diagram according to FIG. 5, point 21 indicates the “Here and Now”. A so-called light cone departs from the horizontal in both directions at 45°, the future lying above the horizontal and the past lying below the horizontal. Due to the curved spacetime in the grey hole surrounding the electron, the latter is in an imaginary time in the grey future. In our calendar, the cold, loss-free current thus flows approximately 5 ns in the future.

1. A method for the loss-free transmission of electrical energy from a direct-voltage source to a lossy load circuit, wherein the direct voltage source is connected, via a high-frequency broadband line, with at least one quantum storage cell feeding the lossy load circuit, so that the electrical energy is transmitted from the direct voltage source to the storage cell in the form of current pulses corresponding to the Dirac function and causing undeterminable virtual voltage drops according to Heisenberg's uncertainty relation.

2. A method according to claim 1, characterized in that a bandwith controller is arranged between the direct voltage source and the quantum storage cell, with the transmission being controlled by changing the frequency bandwith of the line,

3. A method according to claim 1, characterized in that the quantum storage cell is arranged in parallel with a further quantum storage cell via a high-frequency broadband line, and that a broadband controller is preferably arranged between the storage cells.

4. A method according to claim 1, characterized in that a further quantum storage cell is used as said direct voltage source.

5. A method according to claim 1, characterized in that a solar cell or a photodiode is used as said direct voltage source.

6. A method according to claim 1, characterized in that a line designed to be elongate and flat in the manner of a quantum storage cell is used as said high-frequency broadband line.

7. A method according to claim 1, characterized in that further quantum storage cells and/or bandwidth controllers are intermediately arranged in the line.

8. A method according to claim 1, characterized in that the high-frequency broadband line has a bandwith of more than 90 MHz.

9. A method according to claim 1, characterized in that a storage cell comprising chemically strongly dipolar crystals which are mutually separated by an electrically insulating material is chosen as said quantum storage cell, electrical energy being stored in said crystals due to the effect of virtual photon resonance.

10. A method according to claim 9, characterized in that the crystals are present in the form of nano-grains or in the form of layers having nanometer thickness.

11. A method according to claim 9, characterized in that the crystals are present in the rutile crystal modification and, preferably, configured as TiO₂ crystals.

12. A method according to claim 9, characterized in that the crystals and the insulating material are provide in alternately superimposed layers.

13. A device for the loss-free transmission of electrical energy from a direct-voltage source to a lossy load circuit and, in particular, for carrying out the method according to claim 1, characterized in that the direct voltage source is connected, via a high-frequency broadband line, with at least one quantum storage cell feeding the lossy load circuit, so that the electrical energy is transmitted from the direct voltage source to the storage cell in the form of current pulses corresponding to the Dirac function and causing undeterminable virtual voltage drops according to Heisenberg's uncertainty relation.

14. A device according to claim 13, characterized in that a bandwith controller is arranged between the direct voltage source and the quantum storage cell such that the transmission is controllable by a change in the frequency bandwith of the line.

15. A device according to claim 13, characterized in that the quantum storage cell is arranged in parallel with a further quantum storage cell via a high-frequency broadband line, and that a broadband controller is preferably arranged between the storage cells.

16. A device according to claim 13, characterized in that a further quantum storage cell is used as said direct voltage source.

17. A device according to claim 13, characterized in that a solar cell or a photodiode is used as said direct voltage source.

18. A device according to claim 13, characterized in that the high-frequency broadband line is designed to be elongate and flat in the manner of a quantum storage cell.

19. A device according to claim 1, characterized in that further quantum storage cells and/or bandwidth controllers are intermediately arranged in the line.

20. A device according to claim 1, characterized in that the high-frequency broadband line has a bandwith of more than 90 MHz.

21. A device according to claim 1, characterized in that the quantum storage cell comprises chemically strongly dipolar crystals which are mutually separated by an electrically insulating material, electrical energy being storable due to the effect of virtual photon resonance.

22. A device according to claim 21, characterized in that the crystals are present in the form of nano-grains or in the form of layers having nanometer thickness.

23. A device according to claim 21 characterized in that the crystals are present in the rutile crystal modification and, preferably, configured as TiO₂ crystals.

24. A method according to claim 21, characterized in that the crystals and the insulating material are present in alternately superimposed layers.
